(19) United States
(12) Patent Application Publication
(10) Pub. No.: US 2014/0109794 A1
(43) Pub. Date: Apr. 24, 2014

(54) SILICIDE MATERIALS, METHOD TO PRODUCE AND PROTECTIVE TREATMENT FOR SAME

(71) Applicant: Jainagesh Sekhar, Cincinnati, OH (US)

(72) Inventor: Jainagesh Sekhar, Cincinnati, OH (US)

(21) Appl. No.: 13/656,807

(22) Filed: Oct. 22, 2012

(51) Int. Cl. C09D 1/00; B29C 39/38; B05D 5/00; B29C 39/26

(52) U.S. Cl. 106/287.1; 106/287.17; 264/299; 264/483; 264/494; 427/397.7

(57) ABSTRACT

A protective treatment for silicide coated materials and objects, including heating elements so treated, which may be used to improve the electrical stability, oxidation resistance, energy efficiency and performance is disclosed as well as improved silicide materials. Use is made of Al—O type compounds and silicides to treat heating elements in a manner which improves their electrical stability during use. The treatment may consist of a colloidal alumina in slurry form applied to materials and objects. The resultant heating element may be used to conserve energy during its life-cycle because of the use of lower power. It is envisioned that materials other than silicide coated ones may treated in a like manner.

### CROSS-REFERENCE TO RELATED APPLICATION

This application claims the benefit of U.S. provisional patent applications 61/560,849 filed on Nov. 17, 2011 and 61/611,070 filed on Mar. 15, 2012 by the present inventor. This application also utilizes features disclosed in U.S. Pat. No. 7,067,775 filed on Feb. 21, 2003; U.S. Pat. No. 6,099,978 filed on Jan. 28, 1999; U.S. Pat. No. 5,534,119 filed on Jun. 6, 1994; U.S. Pat. No. 5,484,568 filed on Jan. 3, 1994; U.S. Pat. No. 5,558,760 filed on Jan. 6, 1995; and International application PCT/US06/60621 filed on Nov. 7, 2006. The disclosures of all of the above are hereby incorporated by reference in their entirety.

### BACKGROUND

In U.S. Pat. No. 7,067,775 entitled “Treatment for Improving the Stability of Silicon Carbide Heating Elements” a treatment is disclosed, which may be used to improve the electrical stability, energy efficiency and performance of silicon carbide heating elements. Use is made of colloidal binders and silicides to treat silicon carbide heating elements in a manner which improves their electrical stability during use. The resultant heating element may be used to conserve energy during its life cycle because of the use of lower power.

There are several types of element materials commonly used for electrical heating. In addition to those which are discussed below, heating elements made of graphite, aluminum and boron nitride are also sometimes used as electric heaters. Less common materials are Lanthanum Chromite heating elements.

### Metallic Elements (2 Major Types)

The two major types of metallic elements are nickel/chrome (NiCr) and iron-chromium-aluminum (Fe—Cr—Al). Metallic elements are generally the least expensive unless improved by the teachings of PCT/US06/60621, “Materials Having an Enhanced Emissivity and Methods for Making the Same” and U.S. Pat. No. 7,067,775, “Treatment for Improving the Stability of Silicon Carbide Heating Elements” which demonstrate increased power stability for metallic, silicon carbide, semi-conductive, nanostructured and molydisilicide heating elements. Metallic elements however, have the lowest use temperatures. Ni—Cr is limited to use up to 1100° C. whereas the iron-chromium aluminum alloys can be used to about 1300° C. Nichrome, although limited to the lower temperatures, has very good hot strength which allows the elements to be self-supporting whereas the Fe—Cr—Al elements, with poorer hot strength, must be supported.

Metallic elements have the advantage of their electrical resistance remaining constant with time so that as the elements age, it is not necessary to make compensations for changing resistance. Also, metallic elements have constant resistance at all temperatures and a result, inexpensive on/off controls can be used with metallic elements.

Nichrome elements form a chromiumoxide layer when heated in the presence of air. The oxide layer is relatively thick, greenish in color and has a propensity to flake off during cycling. This flaking exposes the base material to further oxidation, which eventually leads to the element failure. This flaking can also lead to product contamination, necessitating that the element should be located in such a position that the oxide will not land on the product.

Certain metallic heating elements may not be used in air. Such are made of pure molybdenum and pure tungsten. These have the drawback of easily oxidizing in air at temperatures as low at 300° C. and must be used in vacuum or inert/reducing atmospheres.

It is also well known that metallic heating elements are not particularly useful primarily because of limited life above 1100° C. when used in air.

### Silicon Carbide Elements

Silicon carbide elements are generally inexpensive heating elements unless improved by the teachings of U.S. Pat. No. 7,067,775 for the temperatures between 1300 and 1500° C. Silicon carbide elements are generally made in rod form and have a hot center zone and two cold ends. They also may of a spiral cut form. The cold ends are impregnated with silicon metal to offer very low resistance and minimize power losses. Silicon carbide elements can take a much higher watt loading per square centimeter than metallic elements and, therefore, fewer elements are required to obtain the same heat input. This occurs primarily because they have a better high temperature capability than metallic heating elements.

Silicon carbide elements are manufactured often from grains of silicon carbide, which are bonded together in a sintering process. Sintering causes bridges between the grains, which provide a means for current flow through the element. Over a period of time, the SiC bridges between the grains will slowly oxidize to silica (SiO₂) which is a poor conductor of electricity. As a result, the resistance of the element increases with time which is a process called aging. A drawback of aging is that the power required to heat the element to the same temperature increases. Over the lifetime of a silicon carbide element, the resistance will generally increase by a factor of 4. Silicon carbide also exhibits a changing resistance with temperature. The resistance is fairly high at room temperature but falls to a minimum value at about 800° C. At element temperatures above 800° C., resistivity increases with rising temperatures. Due to the characteristics of aging and resistance change, silicon carbide elements cannot be used with inexpensive on/off controls but must use silicon-controlled rectifiers (SCR control). SCR control is more expensive than on/off control but can handle the increased voltage as the elements age and also can limit the current during the negative portion of the resistance curve.

Normally when silicon carbide heating elements are used in a furnace, the transformer in the circuit has to be rated for a much higher power than required because of aging. Over the life of the transformer, tappings have to be changed.

### Molybdenum Disilicide Elements

These elements can reach temperatures of 1900° C. (U.S. Pat. No. 6,099,978) and are preferred over the lower cost silicon carbide elements. However, such elements are sometimes prone to pesting (a low temperature oxidation phenomenon). Also, like all ceramic and intermetallic elements, such elements are brittle and SCR control and current limiting electronics are required for operation. Further, due to the high purity required for operation, molybdenum disilicide elements are expensive.

### Zirconia Elements

Zirconia elements are the only elements that can be used in an air atmosphere at temperatures higher than molybdenum disilicide elements. Zirconia elements have only been used in laboratory size kilns because they are only available in small sizes and are very expensive. Also, such elements must be preheated to 1000° C. before conduction even begins. Zirconia elements can be used at kiln temperatures up to 2000° C. but special controls are required.

### Surface Loading

The fundamental operational limitation of any electric heating element is the maximum element surface temperature (MET) that controls the power dissipation (surface load). The maximum surface temperature is reached either when the basic element material begins to decompose (change phase) or when the reaction of the element material with the furnace atmosphere proceeds so rapidly that it makes the element life unacceptably short. In general, limitations of elements are given in terms of the MET in a specific atmosphere. When screening element types for a specific application, a high surface load is a benefit.

In general, the higher the MET, the higher the maximum allowable watt loading. However, each type of element has an absolute maximum watt loading regardless of the element temperature. This limit is based on experience and relates to the deterioration of the basic element material on a microscopic level.

Typical absolute maximum (dry air) watt loadings for the three classes of elements are as follows: Metallic, 8 to 12 W/cm²; SiC, 10 to 15 W/cm²; and MoSi₂, 20 to 30 W/cm². These recommended maximums can vary for element quality within each element type and between manufacturers. Practical design limit watt loadings will always be lower due to the influences of MET, furnace atmosphere and element geometry.

U.S. Pat. No. 7,067,775 discloses a treatment where the stability and other performance measures including emissivity of the silicon carbide is greatly enhanced. Stability is defined as the lack of change in the electrical properties and power draw, with time, during use at a high temperature. Both alpha and beta silicon carbide elements may be improved in performance by the proposed technique and examples of use are given below.

The treatment consists of applying an adherent mixture of silica (a binder) and compounds of molybdenum silicon, i.e., molybdenum silicides (in powder or short fiber form, both forms herein called powder), to a SiC heating element prior to use in a furnace. One or more layers may be applied by brushing, spraying or dipping in an aqueous mixture of silica and molybdenum silicon compounds. The silica may be in any suitable form, which causes adherence of the treatment materials (all forms of crystalline and/or amorphous oxides of silicon are expected to be encompassed by the word silica). The silica may be a gel, a colloid or in the form of powder which is mixed into the molybdenum silicon compound. Both the binder material and the molybdenum silicon material may be either powder, ranging from nanometer size particles to millimeter size particles, or finely dispersed in a fluid such as water or common organic solvents including kerosene or alcohol. The silica could also be obtained by using clay as the binder. Clay, which is an alumina silicate or sodium/calcium alumina silicate, is also referred to as a colloid in this specification.

In one embodiment of U.S. Pat. No. 7,067,775 molybdenum disilicide powder was mixed with silica which was obtained in aqueous dispersed form and applied to a standard silicon carbide heating element material cut from a commercial heating element rod. After the application of three layers by brush, the sample was dried overnight, and tested for stability. The test consisted of measuring and continuously providing the power required (demanded by the heating element) to hold the samples at 1550° C. AC current was used for the test along with an optical pyrometer for temperature measurement, a transformer and other SCR type control electronics. Untreated samples were also tested for comparison. It was noted, that a wide scatter in the stability was seen for the untreated silicon carbide, i.e., all untreated samples invariably showed instability with time, and the power demand kept increasing to maintain the same set temperature. In contrast, the treated sample was found to be exceedingly stable. The temperature of the test was kept high in order to accelerate the possible degradation with time in a reasonable time frame of the test. It is anticipated that the life enhancement and improved performance will be noted for all temperatures of use of the heating element.

In the best embodiment to date, a ratio by weight of one part of Molybdenum disilicide to nine parts of silica were used for the mixture of the treatment. It is anticipated that over the life of the element, the energy efficiency and life are expected to be improved when the heating element has received the treatment described in this application. As silicon carbide containing elements are very commonly employed by the materials manufacturing industry, energy savings is expected to be substantial.

As a final point, the application of the mixture does not change the physical dimensions of the silicon carbide heating element in any substantial sense as the mixture is mostly absorbed in the existing pores. Since the amount of mixture is typically very small no change in the electrical characteristics was found.

It has been found that raw materials used for the products and coatings described above can contain impurities and contaminants such as the elements iron, chromium and nickel and compounds, oxides and mixtures, etc. of the same. Such contaminants may lead to decreased longevity of the finished product, such as a heating element, or to decreased effectiveness of the applied coating. Oxides, such as iron oxide, may be introduced to these products and coatings during production, leading to possible early failure. A method and product is needed to prevent this oxidation that may be used with hot ceramic and hot inter-metallic products and application as presented in this application.

### SUMMARY

An improvement to the absorbing treatment of a molydisilicide or a silicon carbide containing heating element by which the stability and/or performance of the heating element is enhanced by the application of a mixture of a silicide or other powder and often a colloidal binder (even by itself) to the heating element surface of molybdenum disilicide as well as objects so treated and objects formed from the treatment mixture are disclosed in the present application.

The present application deals with a treatment for applying an adherent fluid mixture containing an Al—O—H bond type solution (Both colloidal and non-colloidal) to silicide coated and other coated and non-coated objects and materials. Some bonds may have high covalent character, some may be ionic and some may be vanderwaals in character with not all bond energies being the same. One or more layers may be applied by brushing, spraying or dipping. The layers or coatings may be thin or thick. They may also be fully reactable by thermal changes. After the treatment the entire heating element may be heated, prior to use, in order to either dry or layer the heating element.

### DESCRIPTION

An enhancement consisting of the application of a slurry comprised of a colloidal alumina or Al—O or Al—O-H compound to any silicide, in general, or moly-disilicide (MoSi₂) coated object or material in particular, especially when employed as a heating element is presented in this application. The enhancement represents an improvement to the absorbing treatment to a heating element, possibly containing molydisilicide and silicon carbide, by which the stability and/or performance of the heating element is enhanced by the application of a mixture of a silicide or other powder and a colloidal binder (even by itself) to the heating element surface. (The term colloid is inclusive of nano-molecules or nano-particles.) The compound may be applied in a liquid form or in a solution. One embodiment envisions such colloidal alumina applications on heating elements to improve stability and longevity. A further embodiment is the making of heating elements themselves. An Al—O-H compound is envisioned as well.

The improvement deals with a fluid mixture of Al—O-H type solution (Both colloidal and non-colloidal) to silicide coated, and other coated and non-coated objects and materials or use of said solution as a bulk. The exact placement of atoms in a macromolecular (containing long molecules (see below)) condition is uncertain. One or more layers may be applied by brushing, spraying or dipping. After the treatment the entire heating element may be heated, prior to use, in order to either dry or layer the heating element. Drying is fully contemplated after the mixture is applied. Solutions can be liquid or solid or mixed phase in nature.

The mixture may be a gel or a colloid in the form of a dried or wet powder and may contain silicates, phosphates and carbon containing molecules. The mixture may be comprised of powder ranging from nanometer size particles to millimeter size particles and finely dispersed in fluid such as water or common organic solvents such as kerosene, ethylene glycol, wax or alcohol and mixtures of these and other compounds. Although an Al—O-H or Al—O colloid has been experimentally tested, all forms, including Al—O-H-P and Al—O-H-P-organic, have been considered by the inventor. In the best embodiment to date, a ratio by weight of one part colloidal alumina to nine parts water was used for the mixture of the treatment. Although a colloid is considered as a small size solid (nano size) we consider a long molecule also to be a colloid and correspondingly as a colloid suspension when in fluid form. Long molecules are sometimes referred to as macromolecules.

Particles in the colloid or nanoparticle mixture could be of fractal dimensions or fractal-like scalable shapes of particulates. It is anticipated that the features of the nanostructures presented herein may be described mathematically as having a fractal dimension below 3 and almost never being a full integer (i.e., 1, 2, or 3). A fractal is a mathematical set that has a fractal dimension that usually exceeds its topological dimension and may fall between the integers. Fractals are typically self-similar patterns, where self-similar means they are “the same from near as from far.” Fractals may be exactly the same at every scale or they may be nearly the same at different scales. The envisioned bonds may add to the fractal nature of the repetitive class.

In one embodiment of the treatment, on which the following testing was performed, the mixture was applied to a standard molybdenum disilicide heating element containing a substantial amount of iron (iron is not a desirable element to have in such heating elements as is detrimental to the stability and longevity of the element). Following the application of two to three layers of the mixture by brush or spray, the sample was dried overnight and tested for stability. The test consisted of measuring and continuously providing the power required (demanded by the heating elements) to hold the samples at about 1800° C. in a furnace set to 1750° C. Alternating current (AC) was used for the test along with an optical pyrometer for temperature measurement, a transformer and other SCR (silicon controlled rectifier) type control electronics. Untreated samples were also tested for comparison. All tests were conducted with the same experimental set-up and the conditions were maintained so that a proper comparison could be made.

The element treated with the mixture was light gray in color before heating. After eight minutes at temperature the treated heating element was still light gray in color while an untreated element was considerably darker.

The Al—O and/or Al—O—H bonds possibly interact with the Si—O bond, which could be in a nanofluid form of the moly-disilicide coating which forms in situ, upon heating of the moly-disilicide. This interaction leads to improved stability and greater longevity for coated objects.

It has been found that the application of the mixture does not change the physical dimensions of the molybdenum disilicide heating element when applied as a coating in any substantial sense. It also as been determined that there is not any change in the electrical characteristics when the mixture is used as a coating, as the amount of mixture is typically very small (application of one or two small thin layers, i.e., less than 50 microns in any brush stroke).

It is also envisioned the materials and processes described above may be used to cast products (such as cast micro-heaters) as well as coatings (surface coatings) for products incorporating ideas presented in U.S. Pat. Nos. 5,534,119, 5,484568 and 5,558,760 incorporated herein in their entirety by reference. These cast shape may include nanofluid mixtures of silicides and or nanofluids composed of molecules comprising Al—O or Al—O-H or Al—O—C bonding carbides (Nanofluids may be described as nano-sized particle containing fluids. Here the fluid may be gas-liquid or shear thinning or shear thickening in nature. Nanofluids may also be equated with colloids.). All forms of mixtures, short range order compounds and icosahedral clusters are envisioned.

Cavities cut into foam or other formable or non-formable materials that can be stripped or burnt away may be used to cast heating elements even in situ with coating. Florist foam (foam used in the florist industry for the mounting and display of cut flowers) has proven to be a particularly effective form medium for such casting. Desired shapes are cut easily into the florist foam. The foam may contain pre or post impregnated colloids. The casting material may be comprised of SiC, MoSi₂, clay and nanofluids, but not limited to these materials. A wide variety of shapes may be formed in this manner. Other products may be fabricated using this method of casting.

The nanofluid castings or coatings may be formed in the green state (uncooked mix). Such compositions could then be subjected to a wide variety of heat treatments. Heat treatment methods may include: A two step heat treatment process designed to initially remove free water from a product and subsequently remove any bonded water. Bonded or unbounded water molecules may also be changed in composition by thermal treatments. A plasma treatment could be applied to a surface to cause only local heating of the surface. Enhanced emissivity nanostructure may be added to a structure utilizing the emissivity concept presented in PCT/US06/60621. Sintering of a structure or its parts or surface may be accomplished by the passing of an electric through the structure, part of the structure or a surface of the structure. Silicide complex heating elements may be sintered in this manner during synthesis. Further heat treatment method as described herein may then be performed on these silicide complex heating elements.

Further conditioning methods are contemplated as well. These conditioning methods could be either of the hot or cold variety. Such conditioning methods are intended to cause reactions, sinter an object or to stabilize the properties of an object or composition.

Various compositions are contemplated by the present application. These compositions may have an Al—O, Al—O-H or an Al—O—C bond. It is anticipated that the bonds may be of a type including but not limited to ionic or covalent or they may be a mixture thereof. These bonds may have a clearly defined direction with other bonds (i.e., ionic or covalent). These bonds may be contained within mixtures of silicides, borides, oxides, carbides or nitrides though this list is not exclusive and is not intended to limit the scope of this application.

We claim:

1. A liquid composition comprising Al—O, Al—O-H or Al—O—C bonds, wherein the bonds and or atoms have a defined direction in relation to each other.

2. The liquid composition of claim 1 wherein the type of the bonds is ionic, covalent or a mixture thereof.

3. The liquid composition of claim 1 wherein the composition contains fractal dimensional objects with a fractal dimension less than 3.

4. The liquid composition of claim 1 further comprising a material from the group consisting of silicides, nitrides and carbides.

5. The liquid composition of claim 1 wherein said composition is composed of a nanofluid or a colloid.

6. The liquid composition of claim 1 wherein objects comprising the composition have properties of modified emissivity.

7. The liquid composition of claim 6 wherein the objects, shapes or surfaces are cast.

8. The liquid composition of claim 7 wherein the objects are heating elements and further comprise silicides.

9. A method to produce an active heating object comprised of a colloidal compound, said method comprising pouring the colloidal compound into foam forms and casting the colloidal compound into the foam forms wherein the compound comprises Al—O, Al—O-H or Al—O-C molecules or sections of molecules.

10. The method of claim 8 further comprising removing free water and then removing bonded water from the object.

11. The method of claim 8 further comprising treating the object with plasma in a localized manner.

12. The method of claim 8 further comprising passing electric current through the object to cause sintering of the object in whole or in part.

13. The method of claim 8 further comprising conditioning in a hot or cold state to cause reactions, sinter or stabilize properties.

14. The method of claim 8 wherein the objects are in a green condition.

15. The method of claim 8 wherein the objects are in a cured condition.

16. A coating for a silicide containing material comprising a mixture containing various types of Al—O or AI-O-H colloids.

17. The coating of claim 16 wherein the mixture comprises tungsten silicide powder and colloidal alumina along with other solutions.

18. The coating of claim 16 wherein the mixture comprises silicide powder and colloidal alumina.

19. The coating of claim 16 wherein the mixture is in an aqueous dispersed state.

20. The coating of claim 16 further comprising a binder, wherein the binder is silica and clay in a colloidal state.

21. The coating of claim 16 further comprising a mixture of a colloidal alumina and water.

22. The coating of claim 21 wherein the mixture of water and colloidal alumina compounds is comprised in a weight ratio of about 9:1 respectively.

23. The coating of claim 16 wherein the types of Al—O or Al—O-H colloids comprise Al—O-H-P or Al—O-H-P-organic colloids.

24. The coating of claim 22 further comprising water in a colloidal solution.

25. A method for improving the stability and longevity of silicide containing materials comprising coating the silicide containing materials with Al—O of Al—O-H colloids.

26. The method of claim 22 further comprising drying the silicide containing materials.
